(19) United States
(12) Patent Application Publication
(10) Pub. No.: US 2014/0038006 A1
(43) Pub. Date: Feb. 6, 2014

(54) Device and Method for Checking the Leak-Tightness of an Electrochemical Energy Accumulator

(71) Applicants: Jochen Sturm, Wendlingen (DE); Ruediger Nebelsiek, Stuttgart (DE)

(72) Inventors: Jochen Sturm, Wendlingen (DE); Ruediger Nebelsiek, Stuttgart (DE)

(73) Assignee: DAIMLER AG, Stuttgart (DE)

(21) Appl. No.: 14/110,205

(22) PCT Filed: Apr. 4, 2012
(86) PCT No.: PCT/EP2012/001487

§ 371 Date: Oct. 25, 2013

(30) Foreign Application Priority Data
Apr. 8, 2011 (DE) 10 2011 016 527.4

(51) Int. Cl. H01M 10/42

(52) U.S. Cl. CPC H01M 10/4228
USPC 429/61

(57) ABSTRACT

A device and a method for checking the leak-tightness of an electrochemical energy store includes a detection unit that can detect a gas concentration in a battery housing that is closable. The detection unit is a metal oxide sensor connected to an evaluation unit, and as a function of the detected gas concentration a control signal is automatically generated by the evaluation unit for disconnecting the electrochemical energy store and/or for triggering a binder release unit.

### BACKGROUND AND SUMMARY OF THE INVENTION

Exemplary embodiments of the present invention relate to a device and a method for checking the leak-tightness of an electrochemical energy store that is designed as an individual battery cell or as a battery having a plurality of individual battery cells connected to one another in parallel and/or in series, at least one detection unit being provided by means of which a gas concentration in a housing is detectable.

U.S. Patent Application Publication No. 2007/0229294 A1 discloses a system for detecting a leak in a battery and a method for detecting a leak in a battery. The system has a gas sensor having a gas-sensitive nanoparticle structure containing metal nanoparticles connected by bifunctional or polyfunctional organic molecules.

The gas-sensitive nanoparticle structure is a metal nanoparticle/organic composite structure combined with a semiconducting polymer structure and/or a polymer/carbon black composite structure. The structures have very high sensitivity to volatile chemicals. The gas sensor is a sensor that operates based on analyte-induced changes in its conductivity, capacitance, inductance, dielectric permittivity, polarization, impedance, thermal capacitance, or temperature. The method provides that the gas-sensitive gas sensor is situated near a battery and detects analyte-induced changes in the electrical conductivity, capacitance, inductance, dielectric permittivity, polarization, impedance, thermal capacitance, or temperature in the gas sensor which indicate a defective battery. If an analyte-induced change in the electrical conductivity, capacitance, inductance, dielectrical permittivity, polarization, impedance, thermal capacitance, or temperature is detected in the gas sensor, an output of an optical or acoustic signal and/or a data signal is triggered. The identified defective battery is automatically sorted out in a further method step.

Exemplary embodiments of the present invention are directed to a device and a method, which are improved over the prior art, for checking the leak-tightness of an electrochemical energy store that is designed as an individual battery cell or as a battery having a plurality of individual battery cells connected to one another in parallel and/or in series.

In accordance with exemplary embodiments of the present invention a device for checking the leak-tightness of an electrochemical energy store that is designed as an individual battery cell or as a battery having a plurality of individual battery cells connected to one another in parallel and/or in series, includes at least one detection unit by means of which a gas concentration in a housing is detectable. According to the invention, the housing is designed as a battery housing and is closable, wherein the detection unit is a metal oxide sensor connected to an evaluation unit, and as a function of the detected gas concentration a control signal is automatically generatable by means of the evaluation unit, for example for disconnecting the electrochemical energy store and/or for triggering a binder release unit.

By means of the device according to the invention, when the electrochemical energy store is in operation or also is not in operation, the safety of persons dealing with the electrochemical energy store is increased in a particularly advantageous manner. To be able to ensure the operation of the battery, the electrochemical energy store is continuously monitorable with regard to its leak-tightness by means of the at least one detection unit.

The electrochemical energy store is preferably a high-voltage battery for an electric vehicle, a hybrid vehicle, or a vehicle operated using fuel cells, the individual battery cells in particular being lithium-ion cells.

Detected signals of the at least one metal oxide sensor can be supplied to the evaluation unit, so that flammable and even explosive gas compositions are determinable, and as a function of same, the evaluation unit automatically initiates at least one measure with regard to the safety of persons.

The metal oxide sensor as a unit for detecting the gas concentration preferably includes a ceramic chip having platinum microstructures, and, for example, three gas-sensitive metal oxide layers for gases that are reducible as well as easy or difficult to oxidize, whereby the components may be at least partially situated in a sensor housing.

The mode of operation of the metal oxide sensor is based on a change in the conductivity of the gas-sensitive metal oxide layers upon contact with oxidizable and/or reducible gases. A measuring range of the metal oxide sensor is a function of the type of gas, a gas concentration of several parts per million being detectable as a relative measurement indication.

If a gas concentration is present in the battery housing that is detectable by means of the at least one detection unit, it may be concluded that at least one individual battery cell of the battery is not leak-tight, that electrolyte and/or volatile solvent components of the electrolyte is/are escaping, and that therefore there is a hazard for persons, at least in the immediate area of the battery.

In addition, using the detection unit designed as a metal oxide sensor it is possible, for example in the event of an electronic fire and/or cable fire within the battery housing, to detect combustion gases and supply detected signals to the evaluation unit. In such a case the battery is disconnectable by means of a control signal of the evaluation unit.

In one particularly preferred embodiment, the binder release unit is situated in the battery housing itself, so that the binder is releasable within the battery housing, and binds electrolyte within the battery housing which is escaping from a nonleak-tight individual battery cell. The electrolyte is thus largely prevented from escaping from the battery housing and thus posing a risk to persons.

The binder release unit has a container with a closable opening, the evaluation unit advantageously being connected to a release mechanism by means of which the opening is closed. Due to the connection between the evaluation unit and the release mechanism, it is possible to automatically trigger the binder release unit without manual intervention. The binder is released and becomes distributed in the battery housing. For example, the binder is a liquid absorbent for liquid organic substances.

In one advantageous embodiment, an output unit for outputting an optical, acoustic, and/or haptic warning signal is provided so that, for example, a driver of the vehicle receives information concerning the existing hazard with regard to the electrochemical energy store. A nonleak-tight individual battery cell may have full functionality despite a leak, so that the defect remains unnoticed.

Multiple detection units may also preferably be situated in the battery housing, so that when a plurality of electrochemical energy stores is provided, a detection unit is associated with each energy store. The detected signals can be supplied to the evaluation unit, so that, based on the detected gas concentration, it may advantageously be determined where within the battery housing the nonleak-tight electrochemical energy store or the nonleak-tight individual battery cell is located.

In another advantageous embodiment, the detection unit is situated on and/or in the individual battery cell in the interior of the battery housing in order to detect the gas concentration. If the detection unit is situated in the individual battery cell, a gas concentration is detectable therein, so that a quality state and also an aging state of the individual battery cell are determinable. Decomposition substances of the electrolyte are detectable by means of the detection unit situated in the individual battery cell, on the basis of which the quality state as well as the aging state of the individual battery cell are determinable.

In particular, information concerning the quality state and/or the aging state of the electrochemical energy store when a battery is composed of used individual battery cells is useful. In addition, the determined quality state and/or the aging state is/are an important parameter in the event of replacement, repair, material recovery, and/or disposal of an electrochemical energy store.

Furthermore, the device for checking the leak-tightness of the electrochemical energy store is also usable, for example, during production of electrochemical energy stores.

It is also possible that a negative pressure relative to the external surroundings of the battery housing is technically generated in the battery housing, at least temporarily and, for example, at regular intervals. If an electrochemical energy store is not leak-tight, it is thus possible to accelerate evaporation of electrolyte components.

A method for checking the leak-tightness of an electrochemical energy store that is designed as an individual battery cell or as a battery having a plurality of individual battery cells connected to one another in parallel and/or in series involves detecting a gas concentration in a housing by means of at least one detection unit. According to the invention, the housing is designed as a battery housing and is closed, the gas concentration in the battery housing being detected by means of a metal oxide sensor as a detection unit, and the detected signal being supplied to an evaluation unit, and a control signal for disconnecting the electrochemical energy store and/or for triggering a binder release unit and/or for warning the driver being generated as a function of the detected gas concentration.

If the electrochemical energy store is situated in a vehicle, the gas concentration is detected continuously, i.e., when the vehicle is in operation as well as at a standstill, in a particularly advantageous manner.

In one advantageous embodiment, volatile solvent components of an electrolyte are detected by means of the detection unit, the volatile solvent components being organic carbonates, provided that the electrochemical energy store is designed as a lithium-ion cell or lithium-ion battery. Flammable and even explosive gas compositions in the housing may be detected by detecting the volatile solvent components.

When these types of gas compositions are detected at least one warning signal is generatable and outputtable by means of the evaluation unit. Due to flammable and even explosive gas compositions being detectable, and as a result a warning signal being generatable and outputtable, a health hazard to persons present in the immediate surroundings of the electrochemical energy store is reduced.

When a plurality of electrochemical energy stores is provided, in each case a detection unit in the form of a metal oxide sensor is associated with each energy store in a particularly advantageous manner, so that in the case of a detected gas concentration it may be determined by means of the evaluation unit where a nonleak-tight electrochemical energy store is located. The device greatly simplifies the search for the nonleak-tight individual battery cell. Since a metal oxide sensor as the detection unit has comparatively small dimensions and a relatively low cost, it is possible to provide multiple detection units in a battery housing for checking the leak-tightness of electrochemical energy stores.

### BRIEF DESCRIPTION OF THE DRAWING FIGURES

Exemplary embodiments of the invention are explained in greater detail below with reference to drawings, which show the following:

FIG. 1 schematically shows a sectional illustration of a device according to the invention for checking the leak-tightness of a battery,

FIG. 2 schematically shows an alternative embodiment of the device for checking the leak-tightness,

FIG. 3 schematically shows interconnected individual battery cells, each having a detection unit situated on a cell cover,

FIG. 4 schematically shows a view of an enlarged detail of an individual battery cell having a detection unit situated in an opening in the cell cover, and

FIG. 5 schematically shows a view of an enlarged detail of a base area of the individual battery cell, with an opened pressure relief device.

Mutually corresponding parts are provided with the same reference numerals in all figures.

### DETAILED DESCRIPTION

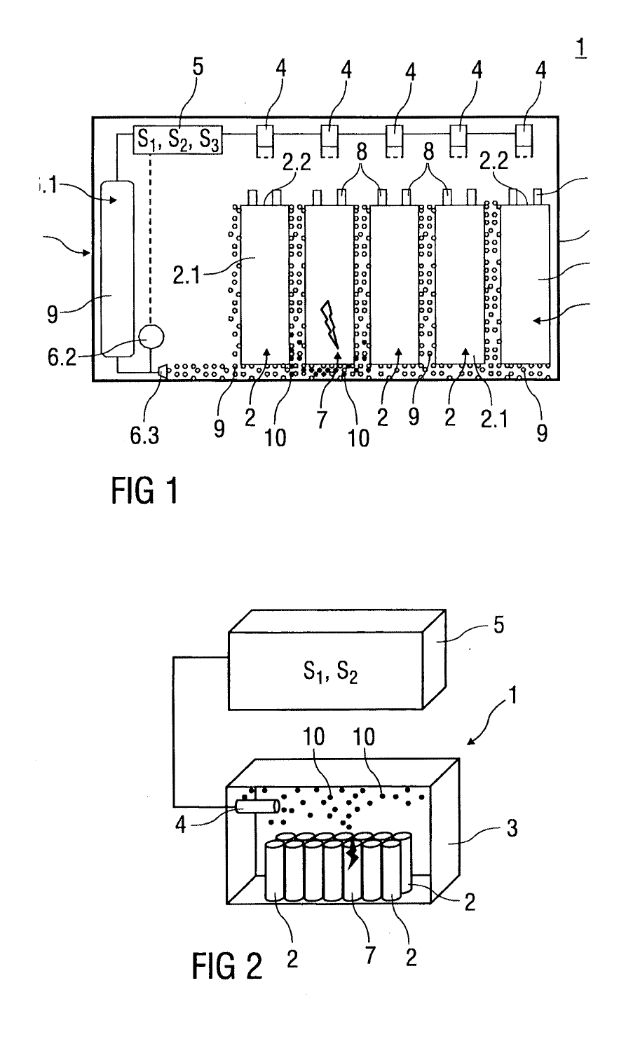

FIG. 1 shows a sectional illustration of a device according to the invention for checking the leak-tightness of an electrochemical energy store which is designed as a battery 1 or as an individual battery cell 2.

The battery 1 is a high-voltage battery for an electric vehicle, a hybrid vehicle, or a vehicle operated using fuel cells.

The device includes a housing designed as a battery housing 3, a plurality of metal oxide sensors as detection units 4, an evaluation unit 5, and a binder release unit 6.

The battery housing 3 is box-shaped with a closable design, the battery housing 3 in the closed state having an essentially leak-tight design.

A predefined number of individual battery cells 2, 7 operating as electrochemical energy stores are situated in the battery housing 3, and are connected to one another in parallel and/or in series. A nonleak-tight individual battery cell 7 is present among the individual battery cells 2.

The individual battery cells 2, 7 each have a cell housing 2.1 in which an electrode arrangement (not illustrated in greater detail), composed of anode layers, cathode layers, and separator layers in between, is situated.

At least two openings are introduced into a cell cover 2.2, as the upper closure of the cell housing 2.1, a pole 8 of the individual battery cell 2, 7 being situated in each of the openings.

One of the poles 8 is connected to the anode layers, and the other pole 8 is connected to the cathode layers of the electrode winding within the cell housing 2.1.

Multiple detection units 4 designed as metal oxide sensors, situated at an inner top side of the battery housing 3, are connected to the evaluation unit 5 of a battery monitoring unit. The detection units 4 are preferably situated directly above the individual battery cells 2, a detection surface of the detection units 4 being oriented in the direction of the individual battery cells 2.

The detection units 4, designed as metal oxide sensors, include a sensor housing, not illustrated in greater detail, in which a ceramic chip having platinum microstructures and preferably three gas-sensitive metal oxide layers for detecting gases that are reducible as well as easy or difficult to oxidize are situated.

In addition, the device for checking the leak-tightness of the individual battery cells 2, 7 includes the binder release unit 6, which likewise is situated within the battery housing 3.

The binder release unit 6 includes a container 6.1 in which the binder 9, for example in the form of a liquid absorbent for liquid organic substances, is stored.

As an alternative to using the container 6.1, a cartridge or some other device for storing the binder 9 may be provided.

The container 6.1 has an opening that is closable by means of a release mechanism 6.2, a valve 6.3 being situated at the opening. The valve 6.3 is opened via the release mechanism 6.2, which may be triggered by pyrotechnical, electrical, and/or electromagnetic means. The binder 9 is thus released, and flows from the container 6.1 into the battery housing 3. For the electrical triggering, it may be provided that predetermined breaking points, for example on the container 6.1 or a line section, are melted through, and the opening is thus enabled for releasing the binder 9.

It is also possible that, in addition to or instead of the valve 6.3, a nozzle, a so-called valve actuator, or some other closable device is situated on the container 6.1.

The container 6.1 and the release mechanism 6.2 are preferably connected to the evaluation unit 5 of the battery monitoring unit.

During operation as well as non-operation of the battery 1, a gas concentration within the battery housing 3 is detected by means of the detection units 4 designed as metal oxide sensors.

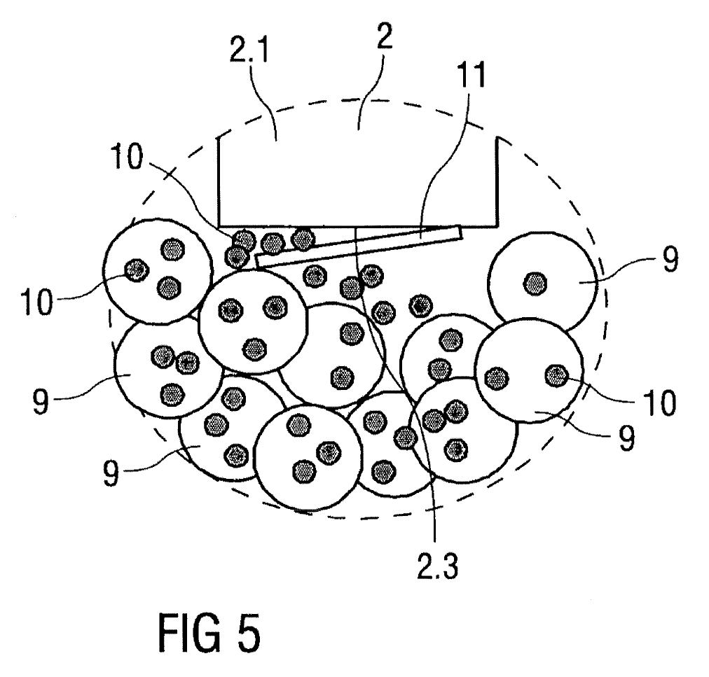

The nonleak-tight individual battery cell 7 has a leak via which volatile solvent components of an electrolyte 10 of the individual battery cell 7 evaporate. In addition, as the result of an impermissible internal pressure prevailing in the individual battery cell 2, caused by an internal short circuit, for example, a pressure relief device 2.3, which is closed by a closure element 11, may open, as illustrated in greater detail in FIG. 5. Due to the pressure relief device 2.3 opening, the pressure may escape from the cell housing 2.1 in a controlled manner without the cell housing 2.1 rupturing. If the pressure relief device 2.3 is no longer closed, electrolyte 10 may escape from the cell housing 2.1 and pose a hazard to persons in the surroundings of the battery 1. When the electrolyte 10 escapes, the volatile solvent components evaporate and are detected by the detection units 4.

When the volatile solvent components of the electrolyte 10 contact the detection units 4, in the form of metal oxide sensors, situated on the top side of the battery housing 3, the conductivity of the gas-sensitive metal oxide layers changes, so that a gas concentration is detectable. That is, each of the detection units 4 detects the gas concentration in the area of its detection surface.

The detected signals of each detection unit 4 are supplied to the evaluation unit 5 and compared to stored threshold values S1 through S3 with regard to the gas concentration.

If the detected gas concentration exceeds a stored first threshold value S1, a first control signal is generated by means of an output unit (not shown) coupled to the evaluation unit 5, via which an output of an optical, acoustic, and/or haptic warning signal can be triggered.

If the battery 3, and thus the device for checking the leak-tightness of the individual battery cells 2, is situated in a vehicle, the optical warning signal is preferably output by means of at least one controllable lighting means situated in an instrument panel.

The acoustic warning signal is preferably output via speakers situated in the vehicle; a steering wheel or a seat of the vehicle, for example, may vibrate as the haptic warning signal.

The driver is made aware of a defect in the battery 1 via the output of the warning signal.

If the detected gas concentration in one of the detection units 4 exceeds a second threshold value S2 stored in the evaluation unit 5, a second control signal is generated by means of the evaluation unit 5 and supplied to the battery monitoring unit. Via the second control signal, the battery 1 is automatically disconnected by means of the battery monitoring unit in order to largely exclude danger to persons in the vehicle and in the immediate surroundings of the vehicle. It is possible that an electrical operation of the battery 1 is interrupted by the automatic opening of protective means.

The driver of the vehicle is preferably informed of the imminent disconnection operation within a predefined time period before the battery 1 is disconnected, for example by means of another acoustic and/or optical and/or haptic warning signal. It is thus possible to park the vehicle at an appropriate location, for example on a roadway shoulder, without hindering or even endangering other road users.

If the battery 1 is subsequently checked by qualified personnel, it is possible to read out the evaluation unit 5 via a diagnostic interface or a docking system situated on the battery monitoring unit. Since the individual detected gas concentrations of each detection unit 4 are stored in the evaluation unit 5 and may be read out from same, based on the detected gas concentrations it may be determined where the nonleak-tight individual battery cell 7 is located within the battery housing 3. That is, if one of the detection units 4 detects a gas concentration that has a higher value than other detected gas concentrations, there is a comparatively high probability that the nonleak-tight individual battery cell 7 is located in the detection range of this detection unit 4. The nonleak-tight individual battery cell 7 may be replaced with an undamaged individual battery cell 2, and the battery 1 may be put back into operation.

If a gas concentration which exceeds a stored third threshold value S3 is detected by means of one of the detection units 4, a third control signal is generated and supplied to the release mechanism 6.2 of the binder release unit 6. The binder release unit 6 is automatically triggered by means of the third control signal. The valve 6.3 is opened by means of the release mechanism 6.2, so that the binder 9 is released, becomes distributed in the battery housing 3, and binds escaped electrolyte 10.

In addition, it may be provided that combustion gases resulting from a cable fire and/or an electronic fire, for example, are detected by means of a number of detection units 4 situated in the battery housing 3. For example, carbon monoxide, carbon dioxide, and/or hydrogen is/are detected as combustion gases. If such combustion gases are detected, a further control signal is preferably generated and the battery 1 is brought into a safe state, for example by switching off the electrical operation.

Furthermore, it is possible to detect flammable and explosive gas compositions in the battery housing 3 by means of the device. If such a gas composition is detected, the output unit outputs at least one warning signal and the battery 1 is preferably disconnected.

FIG. 2 illustrates an alternative embodiment of the device for checking the leak-tightness of the individual battery cells 2 of the battery 1.

The device includes a detection unit 4 situated in the battery housing 3, by means of which a gas concentration is detected. The detection unit 4 is connected to the evaluation unit 5, the detected signals are evaluated, and the appropriate measure is initiated by means of a /generated control signal if at least one of the stored threshold values S1, S2 is exceeded. The device according to FIG. 2 does not include a binder release unit 6, so that the battery 1 is particularly preferably automatically disconnected when an appropriate gas concentration is detected.

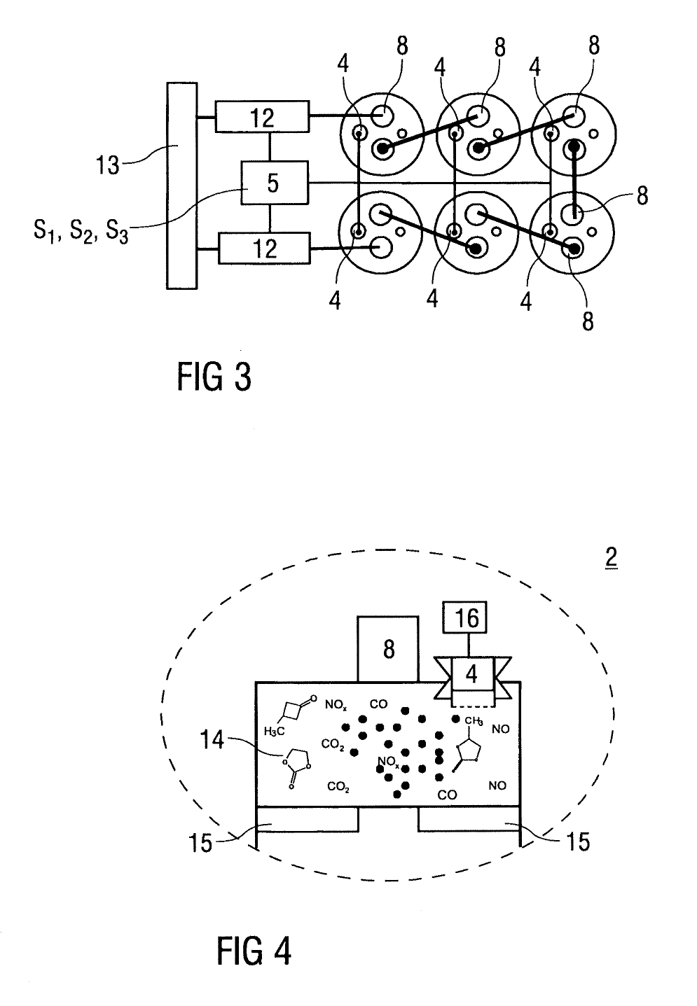

FIG. 3 shows a top view of six individual battery cells 2 connected to one another in series, in each case a pole 8 of negative polarity being connected to a pole 8 of positive polarity in another individual battery cell 2.

A serial terminal 12 of one polarity for tapping the generated voltage is situated at each of two individual battery cells 2 adjacently situated at the edge; an electrical consumer 13 is situated at the serial terminals 12 and is thus supplied with electrical power.

A detection unit 4 in the form of a metal oxide sensor is situated on the cell cover 2.2 of each individual battery cell 2. The detection units 4 of the individual battery cells 2 are preferably connected to the evaluation unit 5 via a data bus. The detection units 4 on the cell cover 2.2 may be provided in addition or as an alternative to the detection units 4 situated on the top side of the battery housing 3.

FIG. 4 shows an enlarged detail of a cell head of the individual battery cell 2, together with the detection unit 4.

An opening is introduced into the cell cover 2.2, in which the detection unit 4 in the form of a metal oxide sensor is situated. A detection surface of the detection unit 4 is present within the cell housing 2.1, the detection surface protruding into a free space 14 for compensation of positive pressure.

For example, the positive pressure in the individual battery cell 2 results from heat generated in the cell housing 2.1 during charging and discharging of the individual battery cell 2. In addition, a pressure control valve that is in fluidic connection with the free space 14 and also with the surroundings of the individual battery cell 2 may be situated on the cell cover 2.2. If the free space 14 is not sufficient for compensating for the positive pressure prevailing in the cell housing 2.1, i.e., if the increase in positive pressure is impermissible for the cell housing 2.1, the pressure control valve opens, so that the positive pressure is reduced.

In addition, spacer elements 15 that prevent the electrode winding from contacting the cell cover 2.2, for example in the event of deformation of the cell housing 2.1, are present in the cell head of the individual battery cell 2. A short circuit within the cell housing 2.1 may occur if the cell cover 2.2 and the electrode winding come into contact. In addition, the spacer elements 15 are used to specify a volume of the free space 14 between the electrode winding and the cell cover 2.2.

If the positive pressure prevailing in the cell housing 2.1 cannot be reduced by means of the free space 14 and by means of the pressure control valve, there is a risk that the individual battery cell 2 may rupture, i.e., the cell housing 2.1 may suddenly fail. For example, the cell housing 2.1 may rupture due to the prevailing positive pressure.

The pressure relief device 2.3 is provided to prevent the cell housing 2.1 from uncontrollably rupturing. The pressure relief device 2.3 is closed via the closure element 11, for example a diaphragm, the closure element 11 being designed in such a way that it opens at a certain pressure that occurs in the cell housing 2.1, so that the positive pressure is reduced, as illustrated in greater detail in FIG. 5.

The detection unit 4 is connected to a control unit 16 that can be supplied with detected signals.

The detection surface of the detection unit 4 protrudes into the free space 14, so that a gas concentration present in the free space 14 is detected. Nitrogen oxides, nitric oxide, carbon monoxide, and/or carbon dioxide are detected by the detection unit 4 as electrolyte decomposition substances. The detected signals are supplied to the control unit 16 and evaluated. For example, threshold values are stored in the control unit 16 and compared to a particular component of a gas in the detected gas concentration. A quality state of the individual battery cell 2 is determined based on the comparison. Additionally or alternatively, an aging state of the individual battery cell 2 may be determined based on the detected gas concentration.

Knowledge about the quality state and/or the aging state of the individual battery cell 2 represents an important factor, for example, for replacement, material recovery, and disposal of the individual battery cell 2.

FIG. 5 shows a base area of an individual battery cell 2 with the pressure relief device 2.3 open. Electrolyte 10 escapes through the pressure relief device 2.3 to the outside, with respect to the cell housing 2.1, and the binder 9 which is released by means of the binder release unit 6 binds the electrolyte 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Battery

2 Individual battery cell

2.1 Cell housing

2.2 Cell cover

2.3 Pressure relief device

3 Battery housing

4 Detection unit

5 Evaluation unit

6 Binder release unit

6.1 Pressurized container

6.2 Release mechanism

6.3 Valve

7 Nonleak-tight individual battery cell

8 Pole

9 Binder

10 Electrolyte

11 Closure element

12 Serial terminal

13 Electrical consumer

14 Free space

15 Spacer element

16 Control unit

S1 First threshold value

S2 Second threshold value

S3 Third threshold value

1-10. (canceled)

11. A device, comprising:
an electrochemical energy store that is an individual battery cell or a battery having a plurality of individual battery cells parallely or serially connected to one another;
a closeable housing enclosing the electromechanical energy store;
at least one detection unit configured to detect a gas concentration in the housing, wherein the at least one detection unit is a metal oxide sensor;
a binder unit containing a binder material; and
an evaluation unit connected to the at least one detection unit and the binder unit, wherein based on the detected gas concentration a control signal the evaluation unit is configured to automatically send a control signal to the binder unit so that the binder unit releases the binder material.

12. The device according to claim 11, wherein the binder release unit has a container with a closable opening through which the binder material is released.

13. The device according to claim 11, wherein the evaluation unit is configured to automatically generate a control signal to trigger output of a warning signal based on the detected gas concentration, wherein the device further comprises an output unit configured to output an optical, acoustic, or haptic warning signal.

14. The device according to claim 11, wherein the evaluation unit is configured to automatically generate a control signal to disconnect the electrochemical energy store as a function of the detected gas concentration.

15. The device according to claim 11, wherein the device includes a plurality of electrochemical energy stores and the device further includes a separate detection unit for each of the plurality of electrochemical energy stores.

16. The device according to claim 11, wherein the detection unit is situated on or in the individual battery cell in an interior of the battery housing.

17. A method for checking the leak-tightness of an electrochemical energy store that is an individual battery cell or as a battery having a plurality of parallely or serially connected individual battery cells, the method comprising:
detecting, by at least one detection unit, a gas concentration in a housing that houses the electrochemical energy store when the housing is closed, wherein the at least one detection unit is a metal oxide sensor;
supplying signals representing the gas concentration to an evaluation unit;
sending, by the evaluation unit as a function of the detected gas concentration, a control signal to disconnect the electrochemical energy store, trigger a binder release unit, or output a warning signal,
wherein there are a plurality of electrochemical energy stores and an individual detection unit is associated with each of the plurality of electrochemical energy stores,
wherein the gas concentration is continuously detected and the plurality of electrochemical energy stores are situated in a vehicle.

18. The method according to claim 17, wherein the detection unit detects volatile solvent components of an electrolyte.
